(19) United States
(12) Patent Application Publication
(10) Pub. No.: US 2002/0078120 A1
(43) Pub. Date: Jun. 20, 2002

(54) Operation facilitating system for data processing apparatus

(76) Inventor: Shuji Kimura, Kato-gun (JP)

Correspondence Address: STAAS & HALSEY LLP, 700 11TH STREET, NW, SUITE 500, WASHINGTON, DC, 20001, US

(21) Appl. No.: 09/839,400

(22) Filed: Apr. 23, 2001

(30) Foreign Application Priority Data
Dec. 15, 2000 (JP) 2000-381557

(51) Int. Cl. G06F 9/00

(52) U.S. Cl. 709/102

(57) ABSTRACT

A data processing system includes a communication network, a data processing apparatus connectable to the network, and a communication terminal connectable to the network. Further, the system includes a job information receiver for receiving job information supplied from the communication terminal via the network, where the job information is related to a required procedure performed by the data processing apparatus. Still further, the system includes a job information register for registering the received job information, a job information specifier for specifying the job information registered in the job information register, and a procedure controller for controlling the above-mentioned required procedure based on the specified job information.

### BACKGROUND OF THE INVENTION

1. Field of the Invention

The present invention relates to an operation facilitating system for a data processing apparatus such as photocopiers, facsimile machines, or cash dispensers. It also relates to a data processing apparatus used in such an operation facilitating system.

2. Description of the Related Art

Data processing apparatuses such as cash dispensers, photocopiers and facsimile machines have been widely used in various places. Initially, these apparatuses were rather simple in function and therefore easy to manipulate. At present, there is a trend toward making these apparatuses multifunctional to meet a wide variety of needs of the users. Unfortunately, as a device is made multifunctional, it tends to become more difficult or even impossible to properly use the device, due to operations to perform with many control keys or switches of the device.

One of the ways to address this problem is to provide a data processing apparatus with a large control panel (preferably, touch panel) so that the user can easily operate the control keys. FIG. 12 of the accompanying drawings shows an example of a touch panel-type information display (reference numeral 200) of a conventional photocopier. Around the touch panel are various kinds of control keys 100.

Though being provided with such an easy-to-use display, the conventional photocopier is still disadvantageous in the following point.

Supposing that the photocopier of FIG. 12 is installed in a convenience store so that any customer can use it. However, since the copier is provided with many selection keys or control buttons, an unaccustomed customer may find it difficult (or even impossible) to make a copy with the device. Things will get worse for the unaccustomed customer if there are some people waiting impatiently for their turn to come. The presence of the waiting people prevents the poor customer from concentrating on his job, so that he may end up with abandoning the copying.

### SUMMARY OF THE INVENTION

The present invention has been proposed under the circumstances described above. It is, therefore, an object of the present invention to provide a system for facilitating the operation of a multifunctional data processing apparatus. Another object of the present invention is to provide a data processing apparatus which is advantageously used for constructing such an operation facilitating system.

According to a first aspect of the present invention, there is provided a data processing apparatus connectable to an external communication terminal via a communication network. The apparatus of the present invention includes: a job information receiver for receiving job information supplied from the external communication terminal via the network, the job information being related to a required procedure performed by the data processing apparatus; a job information register for registering the received job information; a job information specifier for specifying the job information registered in the job information register; and a procedure controller for controlling the above-mentioned required procedure based on the specified job information.

Preferably, the job information receiver may receive a password supplied from the external communication terminal via the network together with the job information. In this case, the job information register stores the job information in connection with the received password and a job acceptance number. Further, the procedure controller may allow the required procedure to be performed only when correct job acceptance number and password are inputted through the job information specifier.

Preferably, the network may be the Internet.

Preferably, the job information receiver may supply a data transmission form to the external communication terminal via the Internet, wherein the job information is inputted to the external communication terminal in accordance with the data transmission form.

According to a preferred embodiment, at least either one of the job information receiver and the job information register may be contained in a main computer, while the job information specifier may be contained in a unit separate from the main computer.

According to a second aspect of the present invention, there is provided a data processing system including: a communication network; a data processing apparatus connectable to the network; a communication terminal connectable to the network; a job information receiver for receiving job information supplied from the communication terminal via the network, the job information being related to a required procedure performed by the data processing apparatus; a job information register for registering the received job information; a job information specifier for specifying the job information registered in the job information register; and a procedure controller for controlling said required procedure based on the specified job information.

According to a third aspect of the present invention, there is provided a storage medium used for a data processing system which includes a data processing apparatus, a communication terminal and a communication network for connecting the data processing apparatus to the communication terminal. The storage medium stores programs to be executed by the communication terminal. The programs may include: a job information generating program for generating job information on the communication terminal, the job information being related to a desired procedure performed by the data processing apparatus; and a job information transmitting program for sending the generated job information from the communication terminal to the data processing apparatus via the network.

Other features and advantages of the present invention will become apparent from the detailed description given below with reference to the accompanying drawings.

### BRIEF DESCRIPTION OF THE DRAWINGS

FIG. 1 is a schematic view illustrating the concept of an operation facilitating system for data processing apparatus according to the present invention;

FIG. 2 is a block diagram showing the main components of a cash dispenser used for the operation facilitating system;

FIG. 3 is a flow chart illustrating the procedure of job information registration;

FIG. 4 is a flow chart illustrating the procedure of money deposit;

FIG. 5 shows an example of a Web page for job information registration;

FIG. 6 shows an example of a Web page confirming the job information registration;

FIG. 7 illustrates how to operate the cash dispenser for completing the desired money deposit;

FIG. 8 shows an example of a Web page for photocopier operation;

FIG. 9 shows the control panel of the photocopier used in a preferred embodiment of the present invention;

FIG. 10 shows an example of a Web page for facsimile machine operation;

FIG. 11 shows the control panel of the facsimile machine used in a preferred embodiment of the present invention; and

FIG. 12 shows the control panel of a conventional photocopier.

### DETAILED DESCRIPTION OF THE PREFERRED EMBODIMENTS

The preferred embodiments of the present invention will be described below with reference to the accompanying drawings.

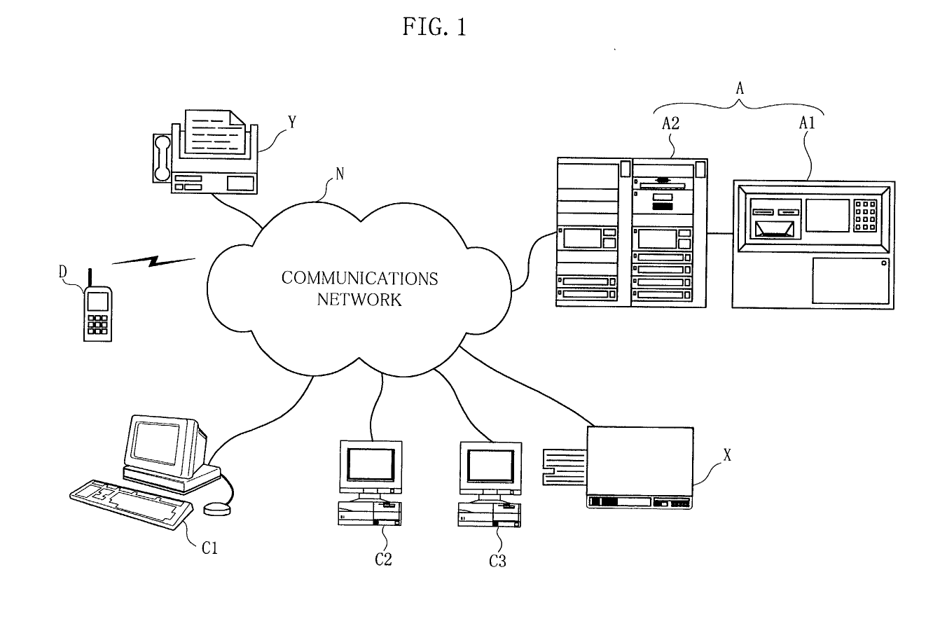

FIG. 1 illustrates the basic concept of an operation facilitating system embodying the present invention. As shown, the system may include various kinds of data processing apparatuses such as a cash dispenser (or automated teller machine) A, a photocopier X and a facsimile machine Y. The cash dispenser A may be installed in a bank, while the copier X and the facsimile machine Y may be installed in a convenience store. The system of the present invention may also include personal computers C1-C3 provided at the users' residences, and a portable telephone D carried by the user.

The computers C1-C3 and the portable telephone D are connectable to the above-mentioned data processing apparatuses A, X and Y through an appropriate communications network N, as shown in FIG. 1. The network N may be the Internet utilizing the existing public or privately leased telephone lines, mobile telecommunications network, etc. The computers C1-C3 and the portable telephone D are provided with hardware and/or software required to connect to the Internet.

In terms of the Internet, the computers C1-C3 and the portable telephone D serve as a “client” connectable to the Internet via a modem, terminal adapter, rooter, etc. Each of the computers C1-C3 may be provided with WWW browser (or Web browser) to access a desired Web page on the Internet. The portable telephone D is capable of sending and receiving audio data as well as text data. The portable telephone D is provided with a Web page displaying function to show a Web page on a small liquid crystal display in accordance with compact HTML (Hyper Text Markup Language) for example.

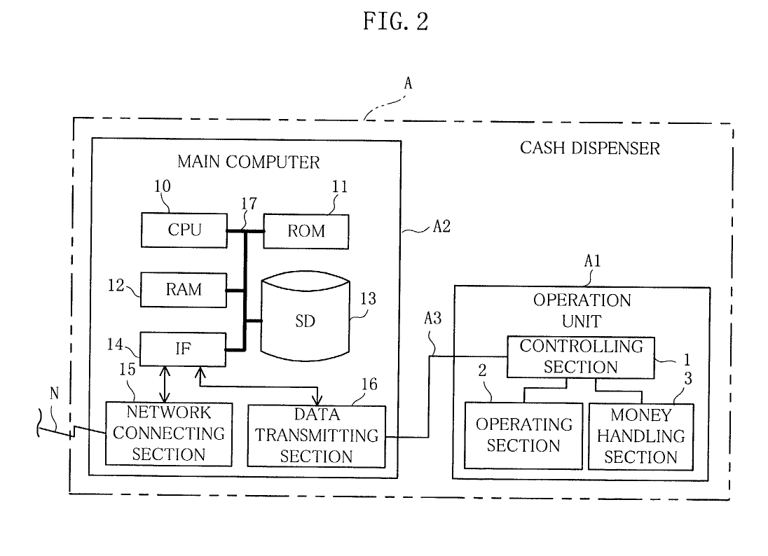

As shown in FIG. 2, the cash dispenser A consists of an operation unit A1 and a main computer A2 for controlling the operation unit A1. The operation unit A1 is connected to the main computer A2 via a connection cable A3. The operation unit A1 may be provided at a place of the bank where customers can easily access the unit, while the main computer A2 may be provided at a place beyond the customers' reach. In the illustrated embodiment, only one operation unit A1 is connected to the main computer A2 for simplicity of illustration. According to the present invention, however, two or more operation units may be connected to the main computer A2.

The operation unit A1 is provided with a controlling section 1, an operating section 2 and a money handling section 3. The controlling section 1 is provided with a microcomputer (not shown) to which the main computer A2 is connected. The non-illustrated microcomputer controls the operation unit A1 through exchanging various control commands or instructions with the main computer A2.

The operating section 2 is provided with a display panel to display information under the control of the controlling section 1. Further, the operating section 2 is provided with key operation detecting means and a card reader. When a key is pressed by the user, the detecting means detects it, and supplies an appropriate signal to the controlling section 1. The card reader reads out data magnetically stored in a cash card or passbook inserted into a card or passbook slot.

The money handling section 3 is provided with a money teller box and a shutter for automatically closing the opening of the box. When the shutter is open, the customer can put money (to be deposited into a bank account) into the box or take out money (to be withdrawn from a bank account) from the box.

The main computer A2 is provided with a CPU (central processing unit) 10, a ROM (read-only memory) 11, a RAM (random-access memory) 12, a storage device 13, an interface 14, a network connecting section 15 and a data transmitting section 16. The CPU 10, the ROM 11, the RAM 12, the storage device 13 and the interface 14 are connected to each other via bus lines 17 including address buses, data buses and control signal buses. The IF 14 is connected to the network connecting section 15 and the data transmitting section 16. The latter is connected to the controlling section 1 of the operation unit A1 via the connection cable A3.

The CPU 10 controls the operations of the main computer A2. The ROM 11 stores programs to be executed by the CPU 10. The RAM 12 provides a working region for the CPU 10 and a data storing region for various kinds of data. The storage device 13 may be provided with a hard disk or magnetic tape for storing data and programs. Besides these data and programs, the storage device 13 may store customer-specific information, software for operating the main computer A2 as a WWW server, and CGI (Common Gateway Interface) programs. The network connecting section 15 may be provided with a rooter or modem for exchanging data between the main computer A2 and the communications network N.

When a customer utilizes the cash dispenser A to e.g. deposit some money into the bank account of a recipient in a conventional manner, the customer visits the bank where the cash dispenser A is installed, and makes necessary operations with the operating section 2.

Specifically, the customer may first press a button allotted for ‘payment’ and insert his (or her) cash card into the card reader (sometimes together with his passbook inserted into the passbook reader). Upon this, the card reader may read out the registered ID number (which has been selected by the customer) and some other customer-specific ID information (such as the customer's bank account number allotted by the bank) from the customer's cash card. The read-out information is sent to the main computer A2 of the cash dispenser A. In the storage device 13 of the main computer A2, the customer's accounting data, balance data, etc. maybe stored in a manner related to the customer-specific ID information.

Then, the customer may be prompted to input his ID number (PIN) to proceed with the operation. When the ID number inputted by the customer coincides with the previously registered ID number, the customer can go to the subsequent steps, which may include rather complicated data inputting operations regarding the name of the banking agency of the recipient, the type of the banking agency, the branch name, the type of the account, the account number, the amount of money to be sent to the recipient, the recipient's name in katakana (angular form of Japanese kana) and kanji (system of Japanese writing using Chinese characters), the sender's name in katakana and kanji and the sender's address.

According to the present invention, as will be described below, the customer can perform the above-mentioned data inputting operations at home or work place for example, without worrying about a long line of people waiting impatiently for their turns to come.

As an example, the customer is now supposed to deposit a certain amount of money into the bank account of a certain person (referred to as the “recipient” below) with the use of the personal computer C1 (FIG. 1), which may be in the customer's house, and the cash dispenser A. It should be noted here that the advantages of the present invention described below can be obtained by using one of the other personal computers C2, C3 or portable telephone D in place of the personal computer C1.

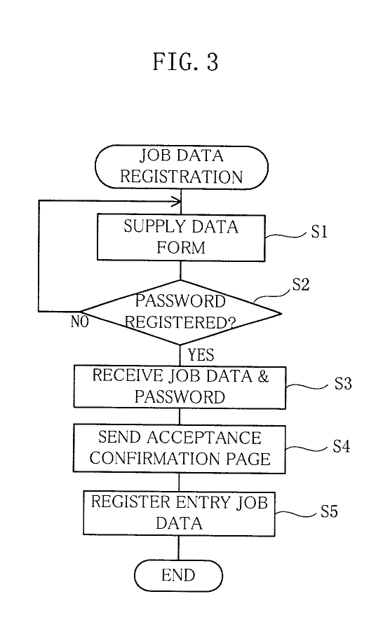

As mentioned above, the main computer A2 of the cash dispenser A serves as a WWW server in relation to the Internet, while the personal computer C1 serves as a client. When the main computer A2 detects an access of the personal computer C1, it starts CGI (Common Gateway Interface) programs which may be stored in the storage device 13. Under the control of the CPU 10, a dialog-type Web page (job information filling form) is supplied from the main computer A2 to the personal computer C1 (S1 in FIG. 3). The Web page is displayed on the monitor of the computer C1.

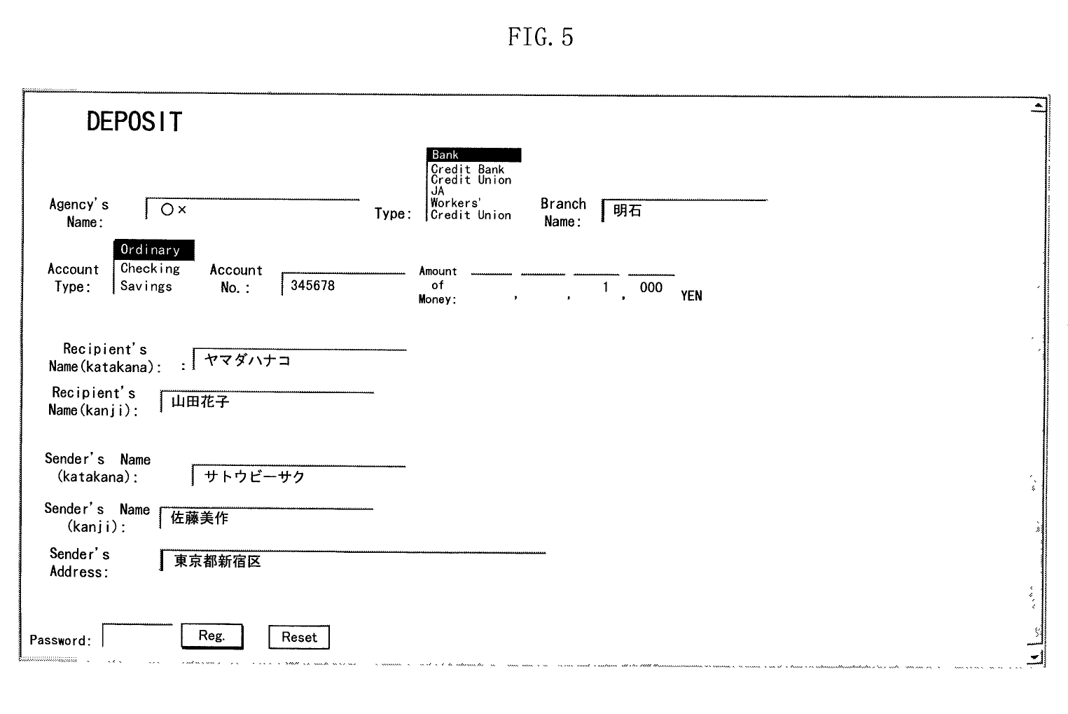

FIG. 5 shows an example of a Web page utilized for depositing money into the bank account of the recipient. As illustrated, the Web page contains several text boxes into which the customer needs to type appropriate data. Specifically, it is required to type into the text boxes the name of the banking agency of the recipient, the branch name of the agency, the account number of the recipient, the amount of money to be sent to the recipient, the recipient's name (katakana), the recipient's name (kanji), the sender's name (katakana), the sender's name (kanji), and the sender's address.

Besides the text boxes, the Web page contains list boxes each showing a list of options to be selected by the customer. In the illustrated example, “Bank” is selected in one list box for the type of banking agency, while “Ordinary Deposit” is selected in the other list box for the type of the account of the recipient.

The above-mentioned various kinds of data typed into the text boxes and selected from the list boxes will be collectively referred to as the “job information” below. It should be noted that conventionally such job information is directly typed in the cash dispenser A by the customer through manipulating the keys or switches of the operating section 2.

After all the job information is properly input, the customer types a personal ID number or password into the text box in the lower-left corner of the Web page. Finally, the customer clicks the registration button next to the text box (S2:YES in FIG. 3). Upon this, the password, together with the previously inputted job information, is sent to the main computer A2. According to the present invention, the password may be the same as or different from the registered ID number of the customer's cash card.

When the password has not been properly typed (for instance, only a three-digit number is typed when a four-digit number is required), or when the registration button has not been clicked for a certain period of time, the CPU 10 returns to S1 in FIG. 3. Before returning to S1, the CPU 10 may cause a message for prompting the input of the correct password to appear on the monitor of the computer C1.

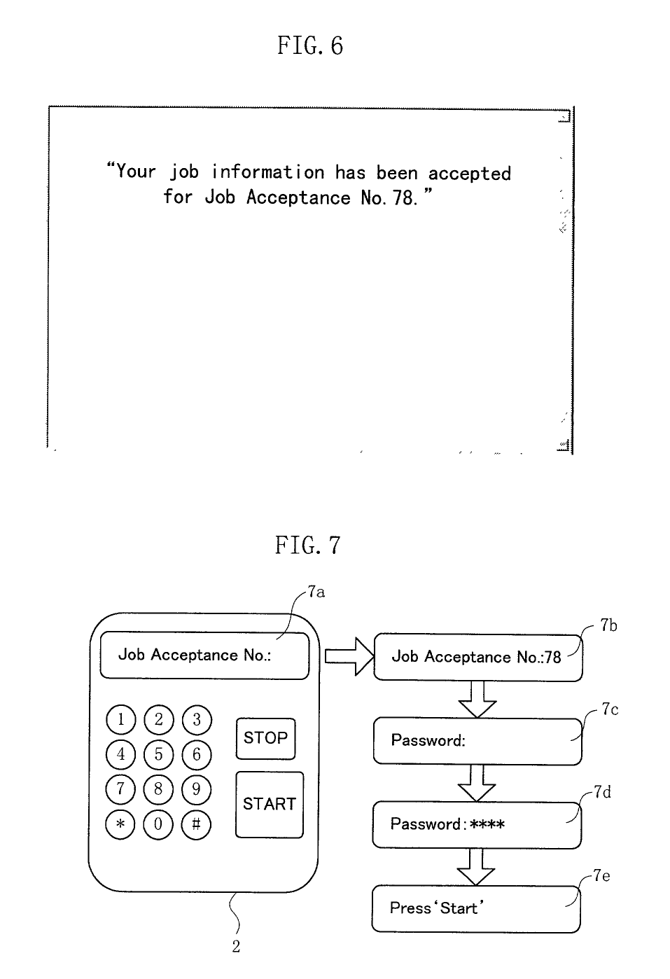

When the main computer A2 receives the correct password and the job information (S3 in FIG. 3), it supplies to the computer C1 a Web page to notify the customer of the acceptance of the job information (S4 in FIG. 3). FIG. 6 shows an example of the acceptance notification Web page presenting a message saying that “Your job information has been accepted for Job Acceptance No. 78.”

The main computer A2 writes the received job information to the storage device 13 (S5 in FIG. 3). The thus stored job information may be referred to as the “entry job information” below. In the storage device 13, the entry job information is associated with the password typed by the customer and the allotted job acceptance number (“78” in the above example). For later use, the customer needs to remember both the allotted job acceptance number and the password of his own choice.

After the job information and the password have been sent to the main computer A2 via the personal computer C1, the customer goes to the bank to perform the following operations with the cash dispenser A.

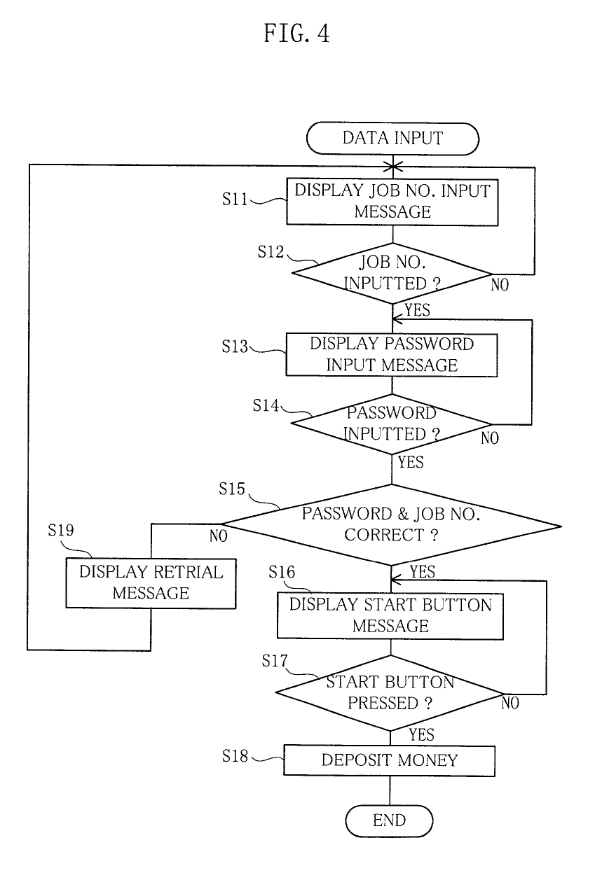

First, the customer operates the operating section 2 of the cash dispenser A to cause a ‘Job Acceptance Number Input’ message to appear on the monitor (S11 in FIG. 4) under the control of CPU 10, as shown in FIG. 7 (see reference sign 7a).

When the customer types his job acceptance number (S12: YES in FIG. 4), as indicated by reference sign 7b in FIG. 7, the CPU 10 causes a ‘Password Input’ message to appear on the monitor (S13 in FIG. 4), as indicated by reference sign 7c in FIG. 7.

If no job acceptance number has been typed for a certain period of time (S12:NO in FIG. 4), the CPU 10 returns to S11 to wait for the input of the number.

When the customer types his password (S14:YES in FIG. 4), four asterisks appear on the monitor, as indicated by reference sign 7d, for keeping the password secure in case anyone is peeking. At the same time, the CPU 10 checks the typed job acceptance number and password against the entry job information registered in the storage device 13 (S15). If no password has not been typed for a certain period of time (S14:NO in FIG. 4), the CPU 10 returns to S13 to wait for the input of the password.

When the correct job acceptance number and password are typed (S15:YES in FIG. 4), the CPU 10 causes a ‘Press Start Button’ message, as indicated by reference sign 7e in FIG. 7, to appear on the monitor (S16 in FIG. 4). When the typed job acceptance number and password are not correct (S15:NO in FIG. 4), the CPU 10 causes a ‘Retrial’ message to appear on the monitor (S19 in FIG. 4), and then returns to S11.

When the customer presses the start button (S17:YES in FIG. 4), the CPU 10 retrieves the entry job information associated with the job acceptance number and the password from the storage device 13. Based on this entry job information, the desired money deposit procedure is performed (S18 in FIG. 4). Specifically, the money the customer has put in the money teller box of the money handling section 3 may be taken in, and the equivalent amount of money is deposited into the bank account of the recipient. Alternatively, the required amount of money may be withdrawn from the bank account of the customer, and deposited into the bank account of the recipient.

If the start button has not been pressed for a certain period of time (S17:NO in FIG. 4), the CPU 10 returns to S16 and waits for the start button to be operated.

According to the above-described system. it is possible for the customer to register the required job information without being disturbed by the presence of other people. Thereafter, the customer only needs to go to the cash dispenser A and make a few simple operations such as inputting a job acceptance number and a password. Accordingly, the operating section 2 of the cash dispenser A can be simply structured, as shown in FIG. 7, which is advantageous to reducing the production cost of the dispenser A.

It should be appreciated that the present invention is not limited to the above embodiment. For instance, use may be made of the photocopier X or facsimile machine Y (see FIG. 1) in place of the cash dispenser A. In this case, a computer serving as a server may be installed on the Internet and connected to the copier X or facsimile machine Y.

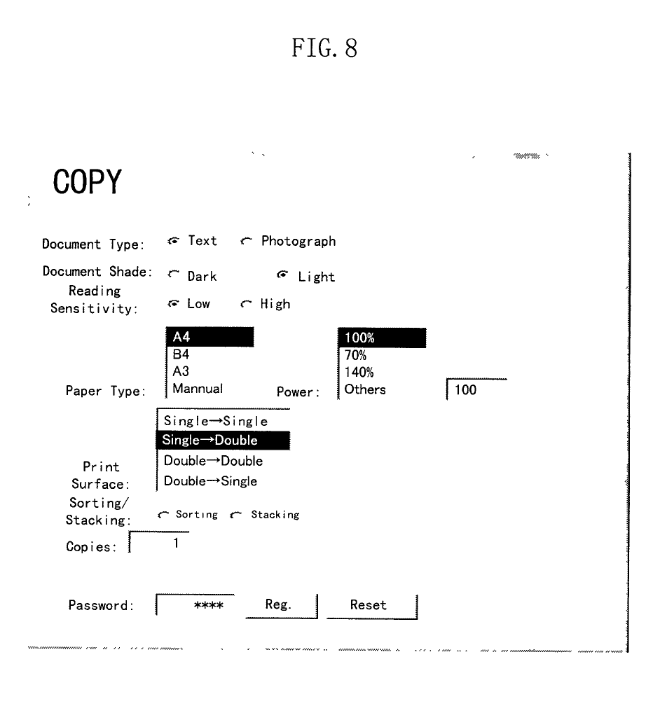

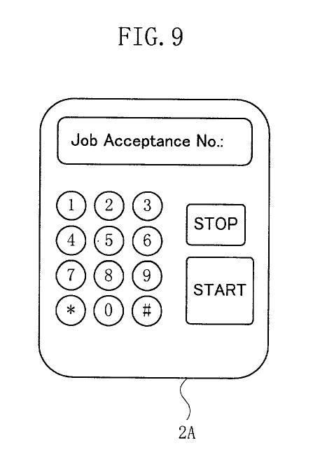

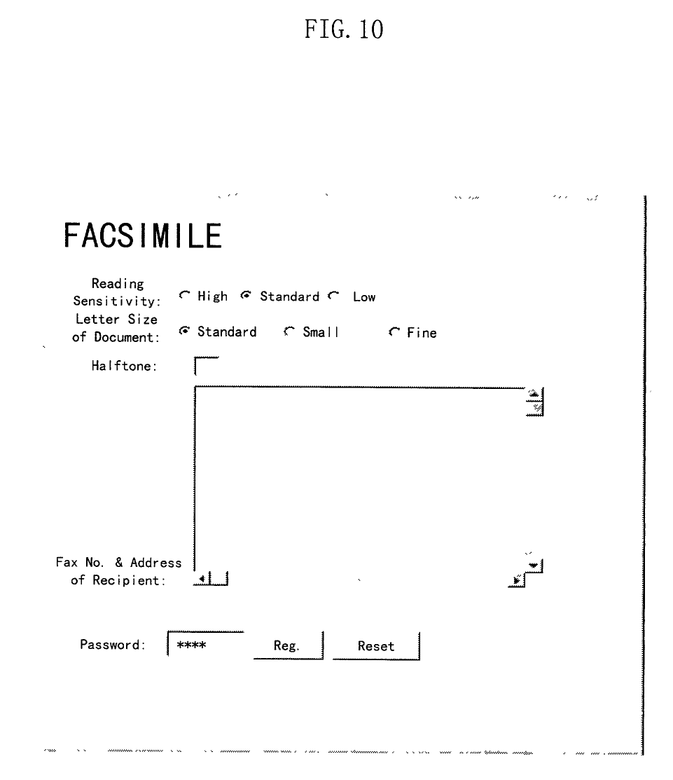

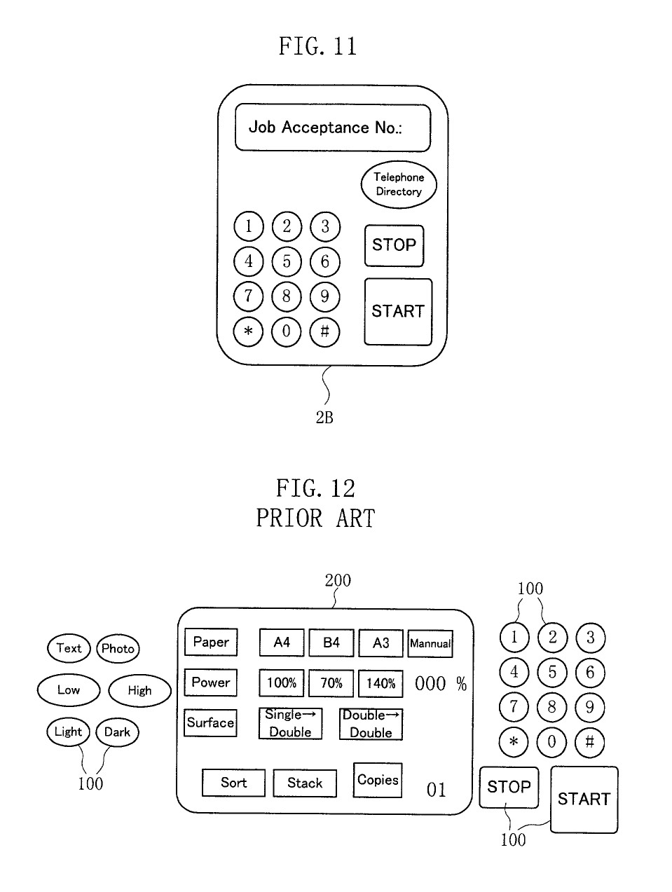

FIG. 8 shows an example of a job information Web page for utilizing the photocopier X, while FIG. 9 shows a control panel configuration of the copier X. In accordance with the Web page of FIG. 8, the user can make selections regarding the type of documents (Text, Photograph), the print shade of documents (Dark, Light), the Reading sensitivity (Low, High), the type of recording sheets (A4, B4, A3, Manual Feed), the magnification (100%, 70%, 140%, Others), the document/copy print surface options (Single→Single, Single→Double, Double→Double, Double→Single), the necessity of sorting (Sorting, Stacking), and the number of required copies. After having made selections about these matters, the user may type the password into the box in the lower-left corner of the Web page. Then, upon the clicking of the registration button, the job information and the password are sent to the server computer on the Internet, and stored in the storage device of the computer. When the computer receives the dispenser A in accordance with CGI programs, and then supplied to the personal computer C1 via a communications network. The present invention, however, is not limited to this. For instance, the Web page may be prepared within the personal computer C1, and then supplied to the main computer A2 of cash the dispenser A for registration. The CGI programs may be replaced by ASP (Application Service Provider) programs.

The present invention being thus described, it is obvious that the same may be varied in many ways. Such variations are not to be regarded as a departure from the spirit and scope of the present invention, and all such modifications as would be obvious to those skilled in the art are intended to be included within the scope of the following claims.

1. A data processing apparatus connectable to an external communication terminal via a communication network, the apparatus comprising:
a job information receiver for receiving job information supplied from the external communication terminal via the network, the job information being related to a required procedure performed by the data processing apparatus;
a job information register for registering the received job information;
a job information specifier for specifying the job information registered in the job information register; and
a procedure controller for controlling said required procedure based on the specified job information.

2. The apparatus according to claim 1, wherein the job information receiver receives a password supplied from the external communication terminal via the network together with the job information.

3. The apparatus according to claim 2, wherein the job information register stores the job information in connection with the received password and a job acceptance number.

4. The apparatus according to claim 3, wherein the procedure controller allows the required procedure to be performed only when correct job acceptance number and password are inputted through the job information specifier.

5. The apparatus according to claim 1, wherein the network comprises the Internet.

6. The apparatus according to claim 5, wherein the job information receiver supplies a data transmission form to the external communication terminal via the Internet, the job information being inputted to the external communication terminal in accordance with the data transmission form.

7. The apparatus according to claim 1, wherein at least either one of the job information receiver and the job information register is contained in a main computer, the job information specifier being contained in a unit separate from the main computer.

8. A data processing system comprising:
a communication network;
a data processing apparatus connectable to the network;
a communication terminal connectable to the network;
a job information receiver for receiving job information supplied from the communication terminal via the network, the job information being related to a required procedure performed by the data processing apparatus;
a job information register for registering the received job information;
a job information specifier for specifying the job information registered in the job information register; and
a procedure controller for controlling said required procedure based on the specified job information.

9. The system according to claim 8, wherein the network comprises the Internet.

10. A storage medium used for a data processing system which includes a data processing apparatus, a communication terminal and a communication network for connecting the data processing apparatus to the communication terminal, the storage medium storing programs to be executed by the communication terminal, the programs comprising:
a job information generating program for generating job information on the communication terminal, the job information being related to a desired procedure performed by the data processing apparatus; and
a job information transmitting program for sending the generated job information from the communication terminal to the data processing apparatus via the network.
